(19) United States
(12) Patent Application Publication
(10) Pub. No.: US 2011/0023035 A1
(43) Pub. Date: Jan. 27, 2011

(54) Command Synchronisation

(75) Inventor: Robert Palmer, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/671,632

(22) PCT Filed: Jul. 31, 2008
(86) PCT No.: PCT/GB08/02604

§ 371 Date: Sep. 1, 2010

(30) Foreign Application Priority Data
Jul. 31, 2007 (GB) 0715000.6

(51) Int. Cl. G06F 9/46

(52) U.S. Cl. 718/100; 712/220

(57) ABSTRACT

The order in which commands issued by a process to one or more hardware processing units should be executed is determined based upon whether the commands are issued to just one hardware processing unit, or to more than one. When the commands are issued to just the one hardware processing unit, the hardware processing unit it allowed to determined their order of execution itself. However, when the commands are issued to more than one hardware processing unit, their order of execution is determined externally to the hardware processing units. This is of particular use in scheduling the execution of commands issued by multi-threaded processes.

### FIELD OF THE INVENTION

The present invention relates to a method for determining the order in which commands issued to one or more hardware processing units by a process should be executed. The present invention also relates to a computing device for performing this method.

### BACKGROUND OF THE INVENTION

Most computing devices include a graphical user interface (GUI) through which applications running on the computing device display content to a user. Some applications may display graphically intense images which require large amounts of processing power. In view of this, computing devices typically include hardware designed specifically to carry out graphics-based processes.

As with any hardware/software interface, client applications are not normally arranged to instruct the hardware directly. Instead, operating systems normally include one or more Hardware Abstraction Layers (HALs) for graphics rendering which provide an application programming interface (API) to the client applications. In this manner, client applications can be written to interface with a single HAL, thereby enabling them to be used with different graphics hardware, without needing the applications' interface code to be re-written. Two examples of industry standard HALs are OpenGL ES and OpenVG.

In some cases, a single HAL is mapped to a single hardware unit, and a computing device may include a number of HAL/hardware pairs. Alternatively, a single hardware unit may be associated with a number of different HALs, each HAL arranged to perform a different graphics function. However the HALs are mapped, the mapping is transparent to the ultimate user.

When using multiple HALs, the operating system must implement a mechanism to ensure synchronicity between them. For example, if a 2D image is rendered by an OpenVG HAL for subsequent use in a 3D environment using an OpenGL ES HAL, the OpenVG HAL must finish rendering the image in 2D before that rendered image is used by the OpenGL ES HAL. If a system is not in place for synchronising HAL processes, the application could cause a corrupt image to be displayed, thereby causing a poor user experience. In addition, the actual graphics environment is likely to be far more complex than just the two sequential processes, so without synchronisation the computing device may well be unusable.

One way in which HAL operations could be synchronised would be to allow the operating system to control HAL synchronisation using system memory as a buffer. However, this is generally inappropriate because hardware operations should be transparent to the user and the operating system. Furthermore, most hardware has its own buffer and serialisation software which would be redundant if the operating system were to take over control of synchronisation operations. It would be preferable for the hardware to handle the synchronisation of the operations of multiple HALs, since this would allow the operating system to concentrate on more general processing requirements. A beneficial consequence of this approach could also be that a thread could continue issuing rendering commands without having to wait for the previous command to be completed by the relevant HAL. This would increase parallelism between operating system processes that are being handled by the CPU and the graphics hardware.

In the prior art, it is known to provide hardware-specific synchronisation by optimising HAL-specific synchronisation objects. In this approach, user thread rendering commands are passed straight to the hardware driver, where those commands are stalled until such time that all previous commands have been executed. This removes the need for the operating system to cause user threads to wait before issuing their commands, and better utilises hardware resources provided by the graphics hardware. This system can use queuing to ensure correct sequencing. However, a problem with this type of hardware-specific synchronisation is that it does not allow synchronisation between multiple HALs.

It is also known to provide synchronisation objects which can be shared amongst multiple HALs. Such objects allow a HAL to wait to execute a command issued by a particular thread until another HAL has finished a rendering job commanded by another thread. However, such trans-HAL objects do not allow the hardware-specific synchronisation provided by the alternative system described above.

The issues described above are not limited to HALs for graphics rendering; there is a need for an improved mechanism for synchronisation between HALs for hardware units in general.

### SUMMARY OF THE INVENTION

In a first aspect, the present invention provides a method for determining the order in which commands issued to one or more hardware processing units by a process should be executed, the method comprising: determining whether the issued commands are directed to just one or to more than one hardware processing units; when the commands are issued to just one hardware processing unit, allowing their order of execution to be determined by this hardware processing unit; and when the commands are issued to more than one hardware processing units, determine their order of execution outside the hardware processing units.

In a second aspect, the present invention provides computer-readable instructions for performing the above method. The computer readable instructions may describe an operating system.

In a fourth aspect, the present invention provides a computing device configured to perform the above method.

### BRIEF DESCRIPTION OF THE DRAWINGS

Embodiments of the present invention will now be described by way of example only, with reference to the accompanying drawings. In the drawings:

FIG. 1 illustrates a data processing system in which command synchronisation has been selected to be performed in the hardware graphic device.

FIG. 2 illustrates a data processing system in which command synchronization has been selected to be performed using system memory.

### DETAILED DESCRIPTION OF THE INVENTION

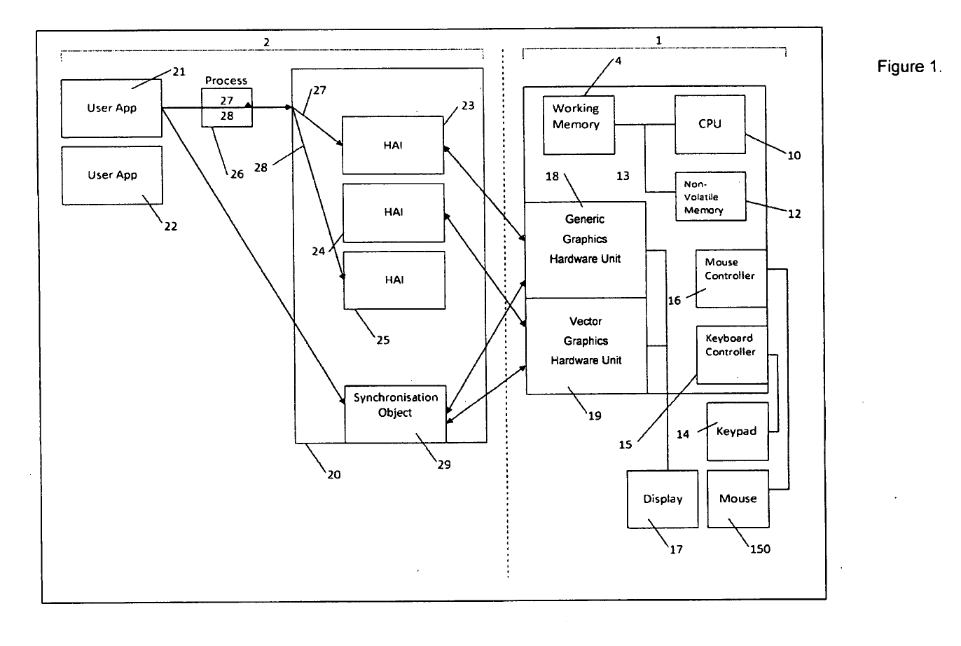

FIG. 1 shows a data processing system, illustrating physical components 1 and software components 2. The hardware components of the system comprise a central processing unit (CPU) 10, working memory (e.g. RAM) 11 and non-volatile memory 12 (e.g. a hard disk or read-only memory (ROM)), all interconnected by a main bus 13. The non-volatile memory stores program code that can be executed by the central processing unit to implement an operating system and user applications, using the working memory 11. A user can provide input to the system by means of a keypad 14 connected to a keyboard controller 15 or a pointing device such as a mouse 150 connected to a mouse controller 16. Output can be provided to a display 17 by means of a generic graphics hardware unit 18 and a vector graphics hardware unit 19. The graphics hardware units 18 and 19 are each arranged to carry out graphics-intensive operations such as image rendering.

In the software domain 2, the operating system 20 provides an interface by means of which the user applications 21, 22 can communicate with the various hardware components of the computing device.

The operating system also includes a number of Hardware Abstraction Layers (HALs). The HALs are arranged to provide user applications with an interface to the graphics hardware units. Each HAL is arranged to carry out a particular graphics function using one of the graphics hardware units. In the present case, the operating system includes a generic 2D and 3D graphics production HAL 23, a 2D vector graphics HAL 24 and 3D graphic production HAL 25. The generic 2D and 3D graphics production HAL 23 and 3D graphics production HAL 25 use the generic graphics hardware unit 18 and the 2D vector graphics HAL 24 uses the vector graphics hardware unit 19.

User applications may need to control the display 17 to present information. To do this they will typically issue appropriate commands by means of API calls to one or more of the HALs. Additionally, each application may have one or more threads running on the CPU 10 under the supervision of the operating system 20. Those threads may independently issue commands to one or more of the HALs.

Some user applications can be arranged to carry out a range of graphics operations. For example, if an application needs to produce 3D graphics for display on the display device 17, the application may produce a process 26 that includes two command threads 27, 28. One of those threads would generate commands for the generic 2D and 3D graphics production HAL 23 to produce a 2D rendered image. The other thread would include commands for the 3D graphics production HAL 25 to produce the 3D graphics. The 3D graphics may be generated by manipulating the 2D rendered image. When a process is created the operating system produces a synchronisation object 29 which will control access to the various HALs. [Is this done for all processes, even if they don't control the display? How does the OS know to produce the synchronisation object?] The application provides the synchronisation object 29 with information indicating which HALs the process's threads will use, and indicating how the process 26 will be used by the HALs. The provision of this information to the synchronisation object 29 before the threads issue their commands to the HALs enables the synchronisation object 29 to control the HAL operations with a view to optimising performance.

The way in which the synchronisation object uses this information will depend on the hardware configuration of the computing device. In one example, if the synchronisation object 29 determines that all the HALs to be used by the process use the same hardware graphics unit then the synchronisation object 29 will not implement synchronisation of the process's HAL commands at the operating system level and will leave the hardware graphics unit to perform the synchronisation. However, if the synchronisation object determines that all the HALs to be used by the process use different hardware graphics units then it will instead implement synchronisation of the process's HAL commands at the operating system level.

In the example described above, an application needs to produce 3D graphics for display on the display device 17. The application produces a process that includes two command threads. One of those threads will generate commands for the generic 2D and 3D graphic production HAL 23 to produce a 2D rendered image. The other thread will generate commands for the 3D graphic production HAL 23 to produce the 3D graphic. When the process is created the operating system creates a corresponding synchronisation object, and the application communicates to the synchronisation object information that defines which HALs the process will use. In this example the process will use only the generic 2D and 3D graphic production HAL 23 and the 3D graphic production HAL 25. Both of these HALs use the same hardware unit, i.e the generic graphics hardware unit 18. The synchronisation object recognises this and passes the responsibility for synchronisation to the hardware unit 18. This may be done by commanding the generic graphics hardware unit 18 to take responsibility for the order in which commands from specific threads or from a specific process or application are performed, or if the generic graphics hardware unit 18 performs such serialisation by default then no such command will be needed. The process can then proceed to issue the HAL commands, and they will be serialised by the generic graphics hardware unit 18.

The generic graphics hardware unit 18 may use hardware-specific serialisation techniques to synchronise the process threads. For example, the generic graphics hardware unit may be arranged to serialise the process thread commands using sequencing. The generic graphics hardware unit 18 may implement a queue in RAM 11 or in memory on the hardware unit 18, whereby each command from the process is received into the memory and queued until it is determined that the command should be executed. This means that neither the software process that is producing the commands nor the HALs that are interpreting the commands and relaying them to the hardware need wait for the hardware to complete the previous rendering task before outputting the next command. This provides a significant advantage in that it moves responsibility for trans-HAL synchronisation from the operating system to the graphics hardware.

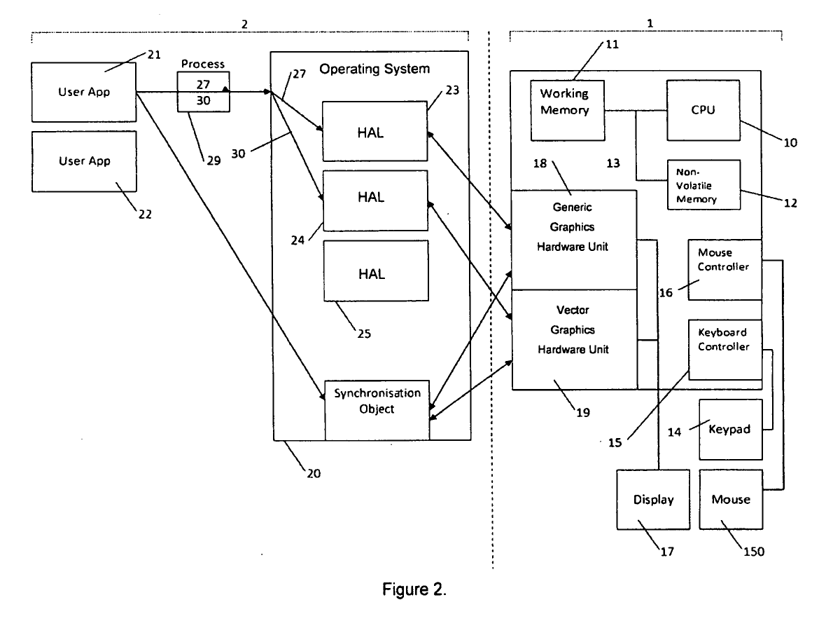

In FIG. 2, process 29 is indicated as including thread commands 27, 30 for HALs relating to different graphics hardware units (for example, the vector graphics hardware unit 19 and the generic graphics hardware unit 18). As in FIG. 1, the application provides the synchronisation object with information indicating which HALs the process's threads will use, and indicating how the process 29 will be used by the HALs. The provision of this information to the synchronisation object before the threads issue their commands to the HALs enables the synchronisation object 29 to control the HAL operations with a view to optimising performance. If the commands are of such a nature that the synchronisation object cannot offload all control of the synchronisation of those commands to the hardware, the synchronisation object could take on the job of synchronising those commands itself.

In one embodiment, the OS based synchronisation object can cause the operating system to create a CPU-based synchronisation object which is controlled by the hardware drivers. The CPU-based synchronisation object would be used to synchronise application threads running on the CPU 10, which may independently issue commands to one or more of the HALs. The CPU-based synchronisation object would synchronise the issuance of commands from the threads running on the CPU under its supervision in order to ensure that they are executed in the correct order. To do that, when one HAL is processing commands from one CPU-based thread of the process, the synchronisation object delays the issuance of commands to the HAL from other CPU-based threads of the process until that HAL has signalled to the CPU-based synchronisation object that it has completed processing the commands it has received from the process. To do that, the synchronisation object may cause commands received from other CPU-based threads of the process to be buffered until they can be issued to the HAL, or it may signal the CPU-based thread(s) to stop issuing commands until the HAL has completed processing its outstanding commands.

It will be appreciated that although the present invention has been described in the context of graphics hardware and graphics commands, the main features and advantages extend to other hardware and command types. In particular, any hardware unit which is accessed by more than one programming interface can take advantage of the present invention. Examples include audio subsystems, network interface cards and storage hardware interfaces.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for determining the order in which commands issued to one or more hardware processing units by a process should be executed, the method comprising:
determining whether the issued commands are directed to just one or to more than one hardware processing units;
when the commands are issued to just one hardware processing unit, allowing their order of execution to be determined by this hardware processing unit; and
when the commands are issued to more than one hardware processing units, determine their order of execution externally to the hardware processing units.

2. The method of claim 1, further comprising:
receiving, from the process, an indication of the hardware processing units it issues the commands to,
wherein the determination is based upon the received information.

3. The method of any preceding claim, wherein the process is a multi-threaded process.

4. The method of any preceding claim, where determining the order of execution externally to the hardware processing units comprises determining their order of execution using a central processing unit.

5. The method of any preceding claim, wherein command serialisation across multiple hardware processing units is achieved by exchanging data between the hardware processing units.

6. The method of any preceding claim, wherein at least one of the hardware processing units is a graphics processing unit.

7. The method of any preceding claim, wherein the process is a multi-threaded process.

8. Computer-readable instructions for performing the method of any preceding claim.

9. The computer-readable instructions of claim 8, describing an operating system.

10. A computing device configured to perform the method of any of claims 1 to 7.

11. The computing device of claim 10, comprising the one or more hardware processing units.

12. The computing device of any of claim 10 or 11, comprising an application programming interface through which processes can issue commands to the hardware processing units.

13. The computing device of any of claims 10 to 12, further comprising an operating system, wherein the determination of the order of execution externally to the hardware processing units is performed by the operating system.

14. The computing device of any of claims 10 to 12, further comprising system memory, wherein the determination of the order of execution externally to the hardware processing units is performed using the system memory.

15. The computing device of any of claims 10 to 13, further comprising a hardware synchronisation component for determining the order in which the hardware processing units execute the commands.
